(19) United States
(12) Patent Application Publication
(10) Pub. No.: US 2002/0185236 A1
(43) Pub. Date: Dec. 12, 2002

(54) Force reducing device and method for adjusting shutter ropes

(76) Inventor: Chia-Tien Wu, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/877,049

(22) Filed: Jun. 11, 2001

(51) Int. Cl. E06B 9/30

(52) U.S. Cl. 160/168.1 R

(57) ABSTRACT

A power saving method for adjusting shutter ropes and the device of the same are disclosed. Winding boxes are classified into two sets. Two winding box sets are symmetrical to a center of the upper beam and each winding box set is fixed with a rope. The two ropes pass through respective holes on the blades, and then winds through a first pulley on the lower beam; and then extends and winds through a second pulley. Then the two ropes passes upwards through the respect holes on the blades. Then the two ropes pass through the outlets of the balance strip; and then are combined as one first combine rope. Then the first combined rope passes through an opening of the rope retaining seat to be formed as a second combined rope. This second combined rope is combined with the first combined rope at the outlets of the rope retaining seat.

### FIELD OF THE INVENTION

The present invention relates to a power saving device for adjusting shutter ropes, wherein other than pulling a shutter with less power, the shutter can be assembled easily.

### BACKGROUND OF THE INVENTION

The shutters with large sizes can not be used to replace cloth window curtains due to a large force being necessary for operating the rope. The current power saving device of shutter has pulleys in the plug at the lower beam. The ropes pass through the same holes of blades so that the holes must be prolonged. Other than difficult in assembly, the strength of the blades must be weakened. If to save more power, the length of the rope must be prolonged with an inverse ratio to the saved power. Therefore, a too long rope makes the outlook of the shutter not beautiful. Furthermore, the operation is inconvenient.

### SUMMARY OF THE INVENTION

Accordingly, the primary object of the present invention is to provide a power saving device for adjusting shutter ropes, wherein other than pulling a shutter with less power, the shutter can be assembled easily.

To achieve the object, the present invention provides a power saving device for adjusting shutter ropes and the method of the same comprising:

An upper beam is embedded with a plurality of pulley boxes, an ohms, a plurality of winding boxes and a rope retaining seat; wherein each winding box has a rolling shaft; and the rope retaining seat has a balance strip;

A lower beam has a plurality of holes and a plurality of pulleys;

A plurality of blades each has holes;

Wherein winding boxes are classified two sets. The two winding box set are symmetrical to a center of the upper beam and each winding box set is fixed with a rope. The two ropes pass through respective holes on the blades, and then winds through a first pulley on the lower beam; and then extends and winds through a second pulley of the same set with the first pulley on the lower beam; then the two ropes passes upwards through the respect holes on the blades, and then passes through the upper sides of rolling shaft below the winding boxes, the two ropes pass through outlets at an upper and a lower side of the balance strip; and then the two ropes are combined as one first combine rope; then the first combined rope passes through an opening at another side of the rope retaining seat to be formed as a second combined rope, this second combined rope is combined with the first combined rope at the outlets of the rope retaining seat to be as a combined rope; when this combined rope is pulled, one end of the rope will left the shutter, and another end of the rope receives the rope to be in an inner space of the upper beam.

The various objects and advantages of the present invention will be more readily understood from the following detailed description when read in conjunction with the appended drawing.

### BRIEF DESCRIPTION OF THE DRAWINGS

FIG. 1 is an exploded perspective view of a first preferred embodiment of the present invention.

FIG. 2 is a schematic view of the path of the rope of FIG. 1.

FIG. 3 is a schematic perspective view showing that two pulleys of the lower beam of FIG. 1 are formed as one set.

FIG. 4 is a left side wire of FIG. 3.

FIG. 5 is an exploded perspective view of the second preferred embodiment of the present invention.

FIG. 6 is a schematic perspective view showing that two pulleys of the lower beam of FIG. 5 are formed as one set.

FIG. 7 shows a left side view and right side view of FIG. 6.

FIG. 8 is a schematic perspective view of a plug.

FIG. 9 is an exploded cross sectional view of the third preferred embodiment of the present invention.

FIG. 10 is a schematic perspective view showing that two coupling means of FIG. 9 are formed as one set.

FIG. 11 is a left side view of the coupling means in the third embodiment.

FIG. 12 is a schematic perspective view of the plug in the third embodiment.

FIG. 13 is an exploded schematic view of the fourth preferred embodiment of the present invention.

FIG. 14 is a schematic perspective view showing that two coupling means of FIG. 13 are formed as one set.

FIG. 15 is a left side view of a coupling means in the fourth embodiment and a right side view of another coupling means in the fourth embodiment.

FIG. 16 is a schematic cross sectional view along line A-A of the winding box 31.

FIG. 17 is a schematic cross sectional view along line B-B of the winding box 32.

FIG. 18 is a schematic cross sectional view along line C-C of the winding box 33.

FIG. 19 is a schematic cross sectional view along line D-D of the winding box 34.

FIG. 20 is a schematic perspective view of one blade in the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

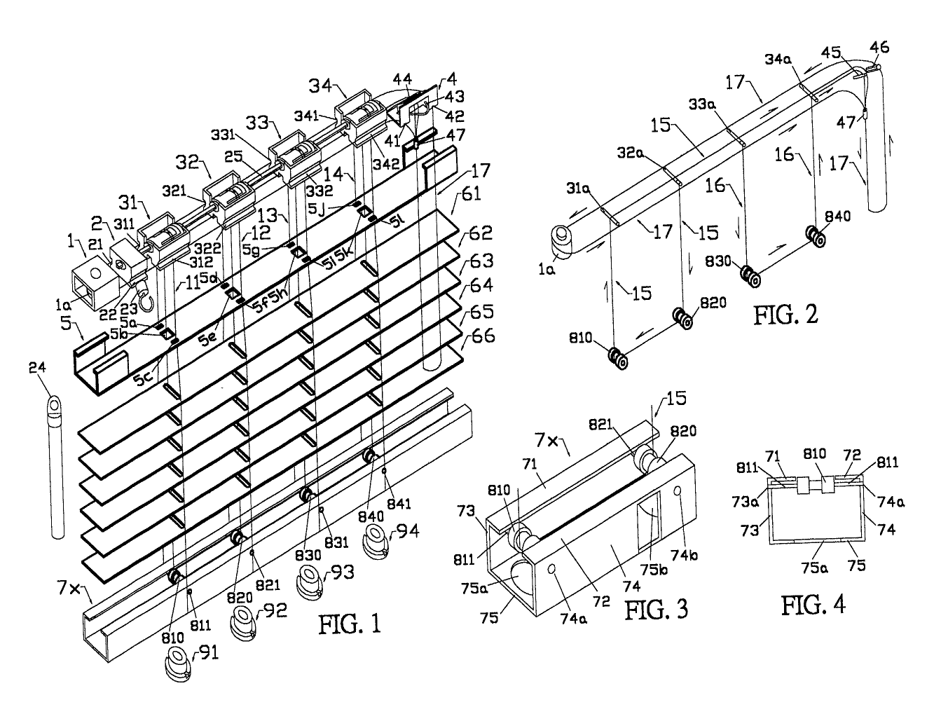

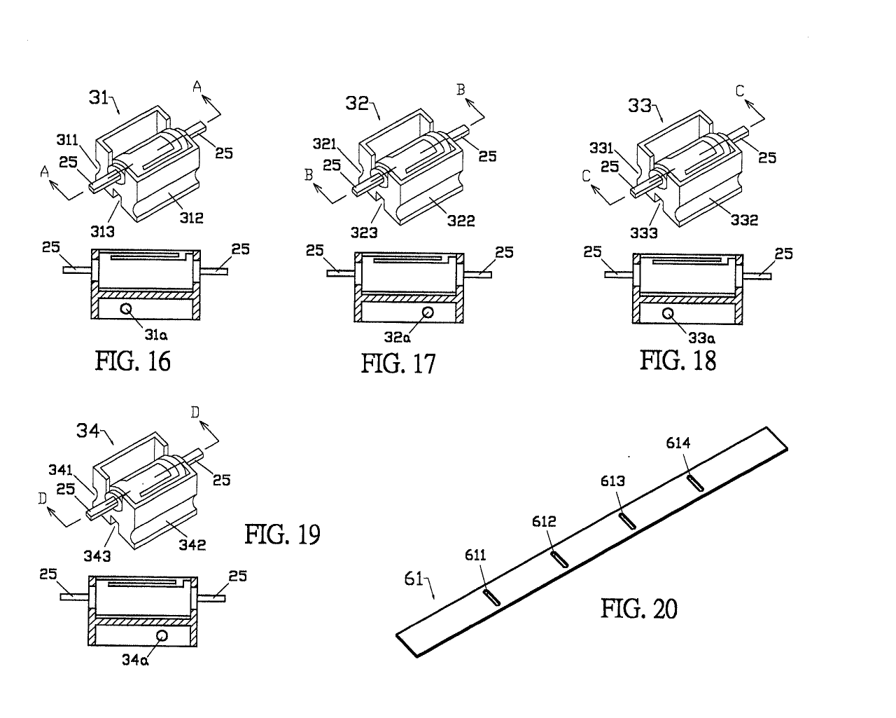

Referring to FIGS. 1, 2, 16, 17, 18, and 19. The upper beam 5 is sequentially embedded with a pulley box 1, an ohm 2, a winding box 31, a winding box 32, a winding box 33, a winding box 34, and a rope retainer 4. The pulley box 1 is installed with a pulley 1a. The ohm 2 has a guide groove 21, a guide groove 22, a hook 23, a rotary rod 24 and a link shaft 25 penetrating through the winding box 31, winding box 32, winding box 33 and winding box 34.

The winding box 31 is installed with a guide groove 311, a guide groove 312, a guide groove 313, and a rolling shaft 31a. The winding box 32 is installed with a guide groove 321, guide groove 322, guide groove 323, and rolling shaft 32a. The winding box 33 is installed with a guide groove 331, a guide groove 332, a guide groove 333, and a rolling shaft 33a. The winding box 34 is installed with a guide groove 341, a guide groove 342, a guide groove 343, and a rolling shaft 34a.

The rope retainer 4 is formed with an opening 41, and an opening 42, a balance strip 43, an outlet 44, a fixing wheel 45 and a fixing wheel 46.

The blade 61, blade 62, blade 63, blade 64, blade 65 and blade 66 are passed by the ladder rope 11, ladder rope 12, ladder rope 13 and ladder rope 14. The upper ends of the ladder rope 11, ladder rope 12, ladder rope 13 and ladder rope 14 pass through the hole 5a, hole 5c, hole 5d, hole 5f, hole 5g, hole 5i, hole 5j and hole 51 of the upper beam 5 to be fixed to the winding box 31, winding box 32, winding box 33, and winding box 34. The lower ends thereof are fixed to the holes (such as hole 75a with respect to the winding box 31, and the hole 75b with respect to the winding box 32) of the lower beam 7x with respect to the winding box 31, winding box 32, winding box 33, and winding box 34 by the plug 91, plug 92, plug 93 and plug 94. The shaft 811, shaft 821, shaft 831, and shaft 841 pass through the pulley 810, pulley 820, pulley 830, and pulley 840 to be fixed to the lower beam 7x.

The winding box 31 and winding box 32 are classified as one set and winding box 33 and winding box 34 are as another set. The rope 15 is fixed to the rolling shaft 32a of the winding box 32 and then passes downwards through the hole 5e and the blade 61, blade 62, blade 63, blade 64, blade 65 and blade 66 at positions with respect to the hole 5e. Then, it winds through the right side of the pulley 820 on the lower beam 7x and then passes through the holes of the blade 61, blade 62, blade 63, blade 64, blade 65 and blade 66 with respect to the hole 5b, and then passes through the rolling shaft 31a, guide groove 313, guide groove 323, guide groove 333, and guide groove 343 to the outlet 44 of the rope retaining seat 4. The rope 16 is fixed to the rolling shaft 33a of the winding box 33, and then passes through the holes 5b and holes of blade 61, blade 62, blade 63, blade 64, blade 65 and blade 66 with respect to the hole 5b. Then it passes through the left side of the pulley 830 on the lower beam 7x and then from the right side of the pulley 840 passes upwards through the holes of the blade 61, blade 62, blade 63, blade 64, blade 65 and blade 66 with respect to the hole 5k and the hole 5k. Then it passes through the rolling shaft 34a, and guide groove 343 of the winding box 34 to the outlet 44 of the rope retaining seat 4.

Then the rope 15 and rope 16 are combined and fixed out of the outlet 44. The extension of the ropes 15 and 16 are formed as a rope 17. The rope 17 passes through the opening 42 to enter into the upper beam 5. Then it passes through the guide groove 341, guide groove 331, guide groove 321, guide groove 311, and guide groove 21 to pass through the pulley 1a and then it passes through the guide groove 22, guide groove 312, guide groove 322, guide groove 332, and guide groove 342. Then it passes out from the opening 41 and passes through the fixing ring 47 with the original section of the rope 17 and is combined therewith.

When the fixing ring 47 or the rope 17 below the fixing ring 47 is pulled leftwards and downwards, the rope 15, rope 16 and rope 17 are also pulled. The rope 16 and rope 17 lift the lower beam 7 (shutter) upwards. The rope 17 stores the rope 15 and rope 16 in the inner space of the upper beam 5 along the periphery of the upper beam 5. If the rope 17 is released rightwards and upwards, then the rope 15 and rope 16 are buckled between the fixing wheel 45 and fixing wheel 46. Therefore, other than power being saved and assembling easily, the rope can be stored.

With reference to FIGS. 3 and 4, in the lower beam 7, the pulley 810 and pulley 820 are classified as one set and are installed with an upper left panel 71, an upper right panel 72, a left panel 73, a hole 73a, a right panel 74, a hole 74a, a hole 74b, a hole 75a, and a hole 75b. The shaft 811 and shaft 821 pass through the pulley 810 and pulley 820 to be fixed to the lower beam 7x. The rope 15 winds downwards through the right side of the pulley 820 and upwards from the left side of the pulley 810. The hole 75a and hole 75b on the bottom plate 75 may be inserted by plug 91 and plug 92 so as to fix the ladder rope 11 and ladder rope 12 in the lower beam 7x. The upper left panel 71 and upper right panel 72 can suffer from the weight of the blade 61, blade 62, blade 63, blade 64, blade 65 and blade 66 so as not to deform.

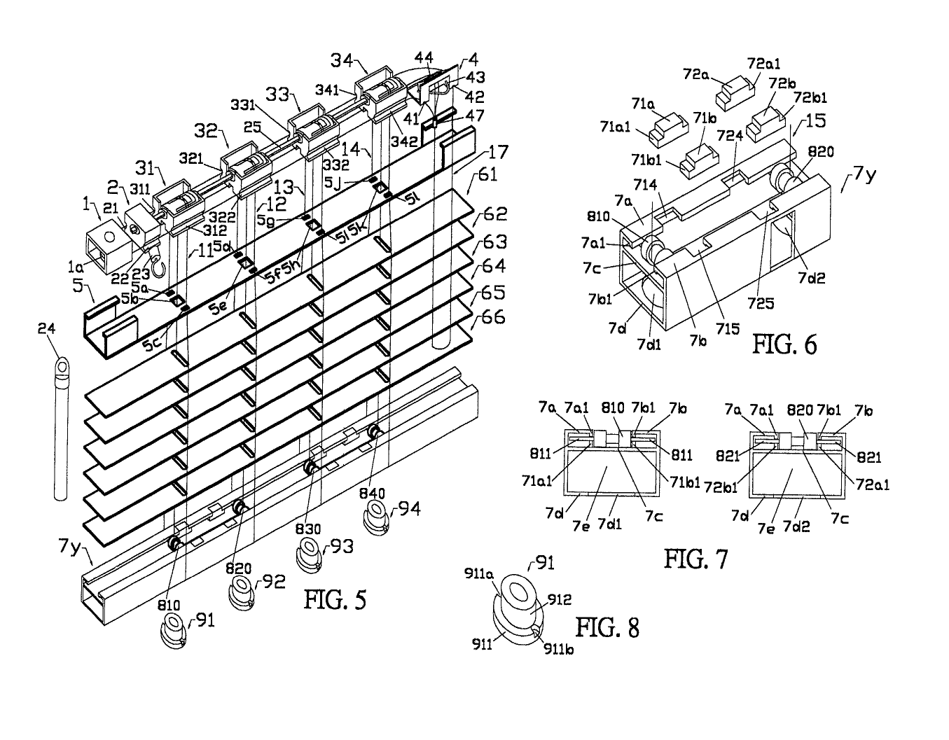

Referring to FIGS. 5, 6 and 7, FIG. 5 is an exploded perspective view of the second preferred embodiment of the present invention. The difference of this embodiment from the first embodiment is that the structure of the lower beam 7y is different from the lower beam 7x, while the other parts are identical.

In the lower beam 7y, the pulley 810 and pulley 820 are formed as one set and have an upper left panel 7a, a flange 7a1, an upper right panel 7b, a flange 7b1, a middle plate 7c, a bottom plate 7d, a hole 7d1, a hole 7d2, plug 71a, a flange 71a1, a plug 71b, a flange 71b1, an opening 714, an opening 715, a plug 72a, a flange 72a1, a plug 72b, a flange 72b1, an opening 724, an opening 725. The rope 15 passes downwards through the right side of the pulley 820 and then passes upwards from the left side of the pulley 810. The hole 7d1 and hole 7d2 on the bottom plate 7d can be inserted by the plug 91 and plug 92 so as to fix the ladder rope 11 and ladder rope 12 in the lower beam 7y. The upper left panel 7a and upper right panel 7b can suffer from the weight of the blade 61, blade 62, blade 63, blade 64, blade 65 and blade 66 so as not to deform. Other than increasing the strength of the lower beam 7y, the middle plate 7c has the function of fixing the plug 71a, plug 71b, plug 72a and plug 72b.

In assembly, the shaft 811 and shaft 821 pass through the pulley 810 and pulley 820 and then enter into the lower side of the upper left panel 7a and upper right panel 7b through the opening 714, opening 715, opening 724 and opening 725. Then the plug 71a, plug 71b, plug 72a and plug 72b are embedded into the opening 714, opening 715, opening 724 and opening 725. The flange 7a1, flange 7b1, flange 71a1, flange 71b1, flange 72a1, and flange 72b1 serve to retain the shaft 811 and shaft 812 to be in proper positions in the lower beam 7y.

The shaft 831 and shaft 841 pass through the pulley 830 and pulley 840 to enter into the lower beam 7y to be formed as another set. The structure is identical to the set formed by the pulley 810 and pulley 820.

As shown in FIG. 8, a schematic perspective view of the plug 91 is illustrated. The plug 9 has a round cylinder 911, a groove 911a, a groove 911b, and a round sleeve 912. The structures of the plug 92, plug 93, and plug 94 are identical to that of the plug 91.

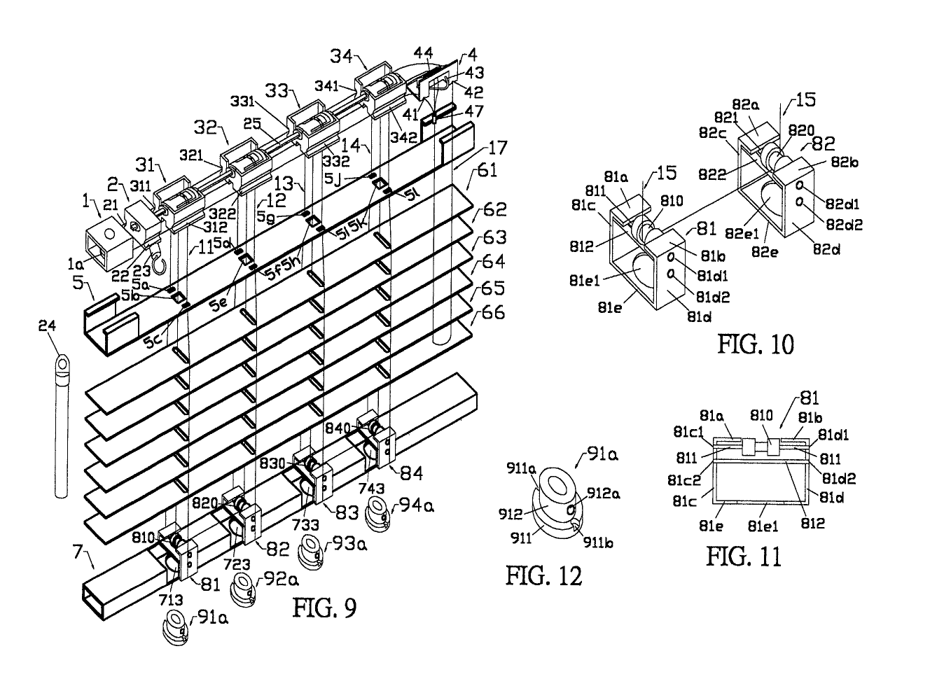

Referring to FIGS. 9, 10, 11, and 12, FIG. 9 is an exploded perspective view of the preferred embodiment of the present invention. The difference of FIG. 9 from the first embodiment illustrated in FIG. 1 is that the lower beam 7 has a coupling means 81, a coupling means 82, a coupling means 83 and a coupling means 84 which are coupled thereon. The other parts are identical.

In the lower beam 7, the coupling means 81 and coupling means 82 are formed as a set and have a pulley 810, a shaft 811, a shaft 812, an upper left panel 81a, an upper right panel 81b, a left panel 81c, a hole 81c1, a hole 81c2, a right panel 81d, a hole 81d1, a hole 81d2, a bottom plate 81e, a hole 81e1, a pulley 820, a shaft 821 a shaft 822, an upper left panel 82a, an upper right panel 82b, a left panel 82c, a right panel 82d, a hole 82d1, a hole 82d2, a bottom plate 82e, a hole 82e1, etc. The bottom of the lower beam 7 has a hole 713, a hole 723, a hole 733 and a hole 743 with respect to the a coupling means 81, a coupling means 82, a coupling means 83 and a coupling means 84. The hole 713 and hole 723 with respect to the hole 81e1 an hole 81e2 on the bottom plate 81e and bottom plate 82a at the bottom of the coupling means 81 and coupling means 82 can be embedded into the plug 91a and plug 92a so that the ladder rope 11 and ladder rope 12 are fixed in the lower beam 7, and the coupling means 81 and coupling means 82 are fixed on the lower beam 7. The shaft 811 and shaft 821 pass through the pulley 810 and pulley 820 and then are fixed to the coupling means 81 and coupling means 82. The rope 15 winds through the right side of the pulley 820 and then passes upwards from the left side of the pulley 810. The shaft 812 penetrates thereby the hole 81d1 and hole 912a, hole 81c2 and the lower beam 7 for enhancing the fixedness between the coupling means 81 and lower beam 7. Similarly, the coupling means 82, coupling means 83 and coupling means 84 have respective shafts passing through the lower beam 7, plug 92a, plug 93a and plug 94a to enhance the fixedness between the coupling means 82, coupling means 83, coupling means 84 and lower beam 7.

The upper left panel 81a, upper right panel 81b, upper left panel 82a, and upper right panel 82b can suffer the weights of the blade 61, blade 62, blade 63, blade 64, blade 65 and blade 66 so as not to deform.

The coupling means 83 and coupling means 84 which are formed as another set have the same structure and principle as the set formed by the coupling means 81 and coupling means 82.

FIG. 12 is a schematic perspective view of the plug 91a. The plug 91a has a round cylinder 911, a groove 911a, groove 911b, a round sleeve 912, and a hole 912. The hole 912a penetrates through the round sleeve 912. The structures of the plug 92a, plug 93a, and plug 94a are identical to that of the plug 91a.

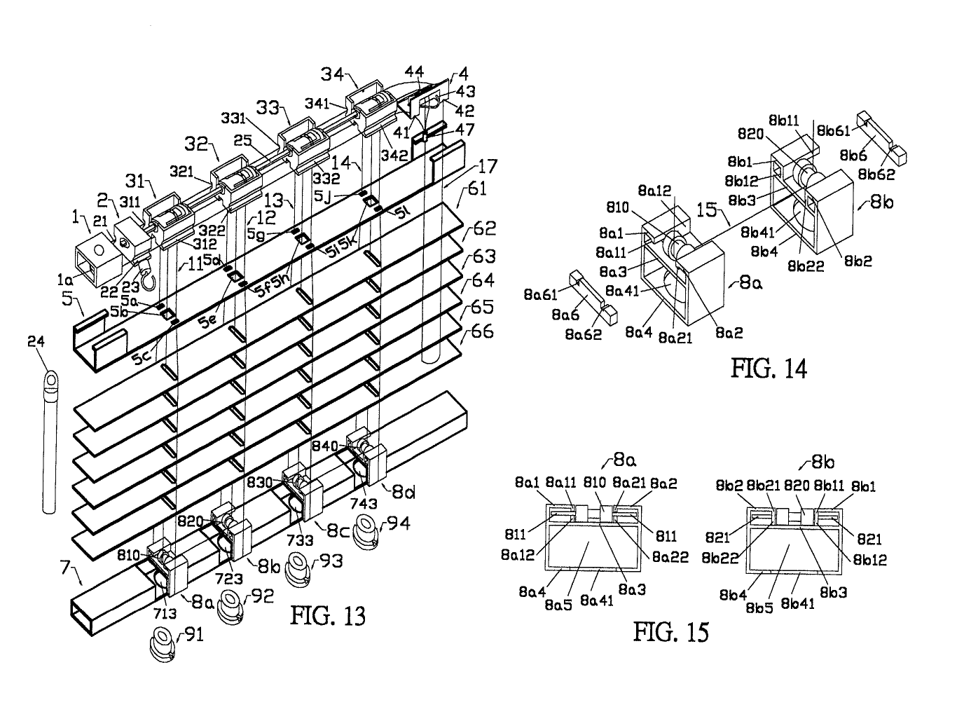

As shown in the FIGS. 13, 14 and 15. FIG. 14 is an exploded perspective view of the fourth preferred embodiment of the present invention. The difference of this embodiment from the first embodiment illustrated in FIG. 1 is that the lower beam 7 has a coupling means 8a, a coupling means 8b, a coupling means 8c and a coupling means 8d which are coupled thereon. The other parts are identical.

In the lower beam 7, the coupling means 8a and coupling means 8b are formed as a set and have an upper left panel 8a1, a flange 8a11, a stopper 8a12, an upper right panel 8a2, a flange 8a21, a stopper 8a22, a middle plate 8a3, a bottom plate 8a4, a hole 8a41, a hole 8a5, a plug 8a6, a groove 8a61, a groove 8a62, a flange 8b21, a stopper 8b22, a middle plate 8b3, a bottom plate 8b4, a hole 8b41, a hole 8b5, a plug 8b6, a groove 8b61, a groove 8b62, a pulley 810, a shaft 811, a pulley 820, a shaft 821, etc. The bottom of the lower beam 7 has a hole 713, a hole 723, a hole 33 and a hole 743 with respect to the bottoms of the coupling means 8a, coupling means 8b, coupling means 8c and coupling means 8d. The shaft 811 and shaft 821 pass through the pulley 810 and pulley 820 and then enter into the coupling means 8a and coupling means 8b along the space between the middle plates 8a3 and 8b3 and flanges 8a11 and 8a21 of the coupling means 8a and coupling means 8b. Then, they are retained in the selected positions in the coupling means 8a and coupling means 8b by the stopper 8a12, stopper 8a22, stopper 8b12, and stopper 8b22. The hole 713 and hole 723 with respect to the hole 8a41 and hole 8b41 with respect to the bottom plate 8a4 and bottom plate 8b4 at the bottoms of the coupling means 8a and coupling means 8b can be embedded into the hole 91 and hole 92 so as to fix the ladder rope 11 and ladder rope 12 in the lower beam 7 and then fix the coupling means 8a and coupling means 8b on the lower beam 7. The rope 15 winds downwards through the right side of the pulley 820 and the passes upwards from the left side of the pulley 810. The upper left panel 8a1, upper right panel 8a2, upper left panel 8b1, and upper right panel 8b2 can suffer the weight of the blade 61, blade 62, blade 63, blade 64, blade 65 and blade 66 so as not to deform.

The coupling means 8c and coupling means 8d which are formed as another set have the same structure and principle as the set formed by the coupling means 8a and coupling means 8b.

A schematic perspective view of the blade 61 is illustrated in FIG. 20, the blade 61 has hole 611, hole 612, hole 613 and hole 614 which are channel of the rope 15 and rope 16. Similarly, the blade 62, blade 63, blade 64, blade 65, blade 66 have respective holes.

By above structure of the present invention, in practical utilization, the number of the winding boxes of each rope set can be changed with the number of the winding box of each product. If the number of the winding box is six, then the first, second and third winding boxes are classified as one set, and the fourth, fifth and sixth winding boxes are classified as one set. If the If the number of the winding box is five, then the first, second winding boxes are classified as one set, and the fourth, fifth winding boxes are classified as one set. The space for receiving the ropes can be installed at any space for receiving the rope, such as the upper side or lower side or front side or the rear side of the upper beam. The constructions are identical to the former.

The present invention are thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A power saving device for adjusting shutter ropes comprising:
an upper beam embedding with a plurality of pulley boxes, an ohms, a plurality of winding boxes and a rope retaining seat; each winding box having a rolling shaft; the rope retaining seat having a balance strip;
a lower beam having a plurality of holes and a plurality of pulleys; and
a plurality of blades each having holes;
wherein winding boxes are classified into two sets; the two winding box set are symmetrical to a center of the upper beam and each winding box set is fixed with a rope; the two ropes pass through respective holes on the blades, and then winds through a first pulley on the lower beam; and then extends and winds through a second pulley of the same set with the first pulley on the lower beam; then the two ropes passes upwards through respect holes on the blades, and then passes through the upper sides of rolling shaft below the winding boxes, the two ropes pass through outlets at an upper and a lower side of the balance strip; and then the two ropes are combined as a first combine rope; then the first combined rope passes through an opening at another side of the rope retaining seat to be formed as a second combined rope, this second combined rope is combined with the first combined rope at the outlets of the rope retaining seat to be as a combined rope; when this combined rope is pulled, one end of the rope will leave from the shutter, and another end of the rope receives the rope to be in an inner space of the upper beam.

2. The power saving device for adjusting shutter ropes as claimed in claim 1, wherein the lower beam is a tube having an long opening at an upper side thereof; a plurality of fixing shafts pass through a plurality of pulleys with respect to the winding boxes and are fixed with the lower beam; a bottom of the lower beam has a hole which is embedded with a plug for fixing ladder ropes in the holes at the bottom of the lower beam.

3. The power saving device for adjusting shutter ropes as claimed in claim 1, wherein the lower beam is a tube having an long opening at an upper side thereof for being passed through by ropes; an enhancing spacer is installed near a lower side of the opening; a plurality of fixing shafts pass through a plurality of pulleys with respect to the winding boxes and then enters into an interior of the lower beam from a plurality of small opening at two sides of the long opening; a plurality of plugs are embedded into the plurality of openings to retain the plurality of shafts in selective positions at the lower beam; a bottom of the lower beam has a hole which is embedded with a plug for fixing ladder ropes in the holes at the bottom of the lower beam.

4. The power saving device for adjusting shutter ropes as claimed in claim 1, wherein two sides of the ohm and winding box have guide grooves and a left and right side of the rope retaining seat have a respective opening.

5. A power saving device for adjusting shutter ropes comprising:
an upper beam embedding with a plurality of pulley boxes, an ohms, a plurality of winding boxes and a rope retaining seat; each winding box having a rolling shaft; the rope retaining seat having a balance strip;
a lower beam having a plurality of holes and pulleys; a plurality of coupling means on the lower beam and positioned with respect to the winding boxes; and
a plurality of blades each having holes;
wherein the winding boxes and coupling means are classified into two sets; the two winding box set are symmetrical to a center of the upper beam and each winding box set is fixed with a rope; the two ropes pass through respective holes on the blades, and then winds through a first pulley on the coupling means of the lower beam; and then extends and winds through a second pulley of another coupling means at the lower beam with respect to the first pulley; then the two ropes pass upwards through the respect holes on the blades, and then passes through the upper sides of a rolling shaft below the winding boxes, the two ropes passes through outlets at an upper and a lower side of the balance strip; and then the two ropes are combined as one first combine rope; then the first combined rope passes through an opening at another side of the rope retaining seat to be formed as a second combined rope, this second combined rope is combined with the first combined rope at the outlets of the rope retaining seat to be as a combined rope; when this combined rope is pulled, one end of the rope will left the shutter, and another end of the rope receives the rope to be in an inner space of the upper beam.

6. The power saving device for adjusting shutter ropes as claimed in claim 5, wherein the coupling means is a short tube having an long opening at an upper side thereof for being passed through by ropes; a hole is at an bottom thereof for being inserted by a plug so that the coupling means is fixed to the lower beam; and then ladder ropes are fixing in the hole at the bottom of the lower beam; at a lower side of the long opening, a fixing shaft passes through the pulley and then is fixed to the coupling means; another shaft penetrates through the coupling means and the lower beam for enhancing the coupling therebetween.

7. The power saving device for adjusting shutter ropes as claimed in claim 5, wherein the coupling means is a short tube having an long opening at an upper side thereof for being passed through by ropes; a hole is at an bottom thereof for being inserted by a plug so that the coupling means is fixed to the lower beam; and then ladder ropes are fixing in the hole at the bottom of the lower beam; at a lower side of the long opening has a enhancing spacer, a fixing shaft passes through the pulley and then enters into the coupling means from a notch at an upper side of the spacer; a plug is embedded into the notch so that the shaft is retained at a selective position of the coupling means.

8. The power saving device for adjusting shutter ropes as claimed in claim 5, wherein two sides of the ohm and winding box have guide grooves and a left and right side of the rope retaining seat have a respective opening.

9. A power saving method for adjusting shutter ropes, comprising the step of:
forming an upper beam, and embedding a plurality of pulley boxes, an ohms, a plurality of winding boxes and a rope retaining seat in an upper beam; wherein each winding box is formed with a rolling shaft; the rope retaining seat is installed with a balance strip;
classifying winding boxes into two sets; wherein the two winding box set are symmetrical to a center of the upper beam and each winding box set is fixed with a rope;
forming a plurality of blades each having holes;
passing the two ropes through respective holes on the blades;
forming a lower beam having a plurality of holes and a plurality of pulleys;
winding the two ropes through a first pulley on the lower beam; and then extending and winding through a second pulley of the same set with the first pulley on the lower beam;
causing the two ropes passing upwards through the respect holes on the blades, and then passing through the upper sides of rolling shaft below the winding boxes, causing the two ropes passing through outlets at an upper and a lower side of the balance strip; and then the two ropes being combined as one first combine rope;
passing the first combined rope through an opening at another side of the rope retaining seat to be formed as a second combined rope;
combining the second combined rope with the first combined rope at the outlets of the rope retaining seat to be as a combined rope;
wherein when this combined rope is pulled, one end of the rope will left the shutter, and another end of the rope receives the rope to be in an inner space of the upper beam.
